(19) United States
(12) Patent Application Publication
(10) Pub. No.: US 2015/0161572 A1
(43) Pub. Date: Jun. 11, 2015

(54) METHOD AND APPARATUS FOR MANAGING DAILY WORK

(71) Applicant: Samsung Electronics Co., Ltd., Gyeonggi-do (KR)

(72) Inventors: Yangkyun Oh, Gyeonggi-do (KR); Sucheol Cheong, Seoul (KR); Sangchul Baek, Seoul (KR)

(21) Appl. No.: 14/565,233

(22) Filed: Dec. 9, 2014

(30) Foreign Application Priority Data
Dec. 9, 2013 (KR) 10-2013-0152077

(51) Int. Cl. G06Q 10/10

(52) U.S. Cl. CPC G06Q 10/1097

(57) ABSTRACT

Disclosed are a method and an apparatus for logging a user event related to a daily work using an electronic device and managing a daily work based on the user event. A method of managing a daily work using an electronic device, the method includes recording data related to an event when an event occurrence related to a daily work is detected. The method also includes displaying details of a daily work generated from the data related to the event on a screen at a time point in which a pre-configured condition is satisfied. Furthermore, various embodiments can be proposed based on technological ideas of the present disclosure.

### CROSS-REFERENCE TO RELATED APPLICATION(S) AND CLAIM OF PRIORITY

The present application is related to and claims priority from and the benefit under 35 U.S.C. §119(a) of Korean Patent Application No. 10-2013-0152077, filed on Dec. 09, 2013, which is hereby incorporated by reference for all purposes as if fully set forth herein.

### TECHNICAL FIELD

The present disclosure relates to a method and an apparatus for logging a user event related to a daily work using an electronic device and managing a daily work based on the user event.

### BACKGROUND

Recent electronic devices have been developed in not only the conventional pocket type but also a wearable type on the strengths of development of a semiconductor technology and a communication technology. The wearable electronic device has been developed by advocating a type such as a watch, glasses, or the like.

According to development of a storage technology and a battery technology, a requirement of a consumer who wants to store trivial records such as a conversation which is exchanged in daily life, a shopping content, or the like has increased. A so-called life logging service refers to a service which supports to store even a trivial event of daily life so as to be processed according to a user's need. Especially, a recent wearable electronic device has been miniaturized, lightened and designed to enable a user to always wear the electronic device, which enables the prospect of a life logging era in which a user's daily information is easily recorded even while the user is not actively aware.

### SUMMARY

According to various embodiments of the present disclosure, a method and an apparatus for managing a daily work can collect information on a situation which a user encounters using an electronic device and processing the information so as to notify the user of information on the daily schedule.

To address the above-discussed deficiencies, it is a primary object to provide a method of managing a daily work using an electronic device. The method includes recording data related to an event when an event occurrence related to a daily work is detected. The method also includes displaying details of a daily work generated from the data related to the event on a screen at a time point in which a pre-configured condition is satisfied.

In accordance with another aspect of the present disclosure, there is provided a daily work managing apparatus. The daily work managing apparatus includes a storage unit that when an event related to a daily work occurs, stores data related to the event and stores a condition in which details of a daily work generated from the data related to the event are displayed on a screen. The daily work managing apparatus also includes a controller that when the event related to the daily work occurs, controls to record data related to the event and to display details of a daily work generated from the data related to the event on the screen at a time point at which the condition is satisfied.

In various embodiments of the present disclosure, a daily work which occurs in daily life can be identified through a life logging function and details of a daily work extracting function.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a block diagram showing a configuration of an electronic device according to an embodiment of the present disclosure.

FIG. 2 illustrates a process of an order of a daily work management operation in an electronic device according to an embodiment of the present disclosure;

FIG. 3 illustrates a time table type of details of a daily work according to an embodiment of the present disclosure;

FIG. 4 illustrates a function of supporting only a selected item among generated details of a daily work to be stored according to an embodiment of the present disclosure;

FIG. 5 illustrates details of a daily work displayed by being interconnected with an auxiliary program according to various embodiments of the present disclosure;

FIG. 6 illustrates details of a daily work stored in a diary form in a daily work management method according to an embodiment of the present disclosure; and

FIG. 7 illustrates that data related to an event is executed in a daily work management method according to an embodiment of the present disclosure.

### DETAILED DESCRIPTION

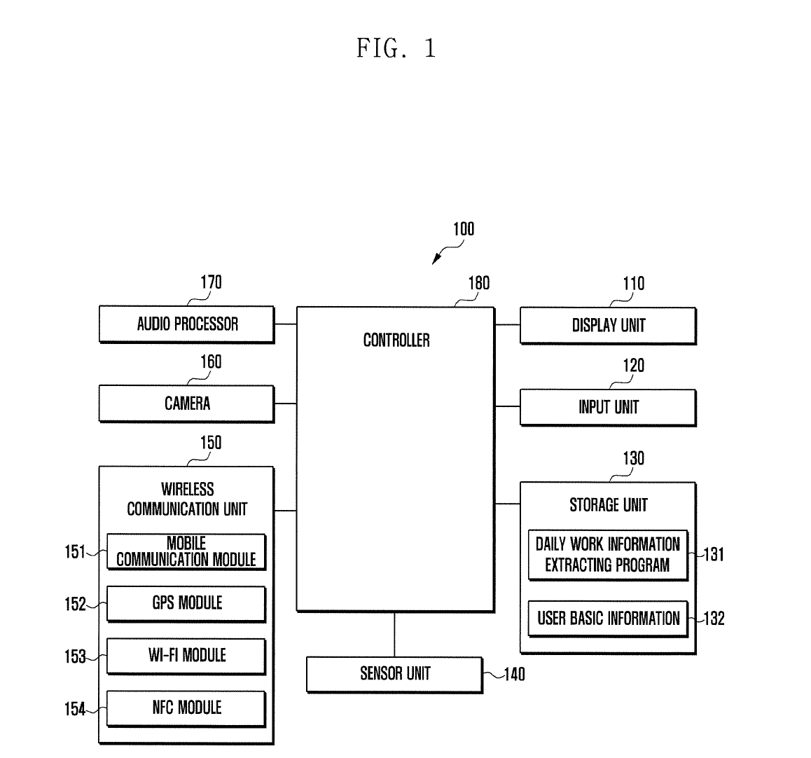

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system and method. Hereinafter, various embodiments will be described in detail with reference to the accompanying drawings. It should be noted that the same elements will be designated by the same reference numerals although they are shown in different drawings. Further, a detailed description of a known function and configuration which may make the subject matter of the present disclosure unclear will be omitted. Hereinafter, it should be noted that only the descriptions will be provided that may help understanding the operations provided in association with the various embodiments of the present disclosure, and other descriptions will be omitted to avoid making the subject matter of the present disclosure rather unclear.

FIG. 1 illustrates a block diagram showing a configuration of an electronic device 100 according to an embodiment of the present disclosure.

The electronic device 100 may include a display unit 110, an input unit 120, a storage unit 130, a sensor unit 140, a wireless communication unit 150, a camera 160, an audio processor 170, and a controller 180. Further, the storage unit 130 may include a daily work information extracting program 131 and user basic information 132 and the wireless communication unit 150 may include a mobile communication module 151, a Global Positioning System (GPS) module 152, a Wi-Fi module 153, and a Near Field Communication (NFC) module 154.

First, the display unit 110 may be formed of a Liquid Crystal Display (LCD), Organic Light Emitting Diodes (OLED), Active Matrix Light Emitting Diodes (AMOLED), or the like. The display unit 110 may visually provide a user with various information, such as an image, a document, a video, or the like, executed in an electronic device. When information related to the event is collected according to an occurrence of an event related to a daily schedule, the display unit 110 according to the embodiment of the present disclosure may display an alarm screen which notifies that the information is collected. In this event, the event may be, for example, a movement event such that information related to the event can be a GPS signal, or the like. That is, when a user's movement is detected, the display unit 110 may display a screen which notifies that movement information based on the GPS signal is recorded. Further, when information collected through the method as described above is accumulated and then a pre-configured notification situation (e.g., specific time) occurs, the display unit 110 may display a screen for notifying that the collected information exists. For example, the screen may be displayed with a memo type or an icon type on a part of the screen. When the user desires to identify collected information in response to the notification, the display unit 110 may display a user's daily work in a time table form based on the collected information.

The input unit 120 may perform inputs of text and external keys, or the like in the electronic device. The input unit 120 according to the embodiment of the present disclosure may support a text input so as to enable a user's detailed of daily work displayed based on the collected information to be corrected. In addition, the input unit 120 may support a key input which allows the user to select whether the information is stored or deleted.

The storage unit 130 may store a program and data used for an operation of an electronic device. The storage unit 130 according to the embodiment of the present disclosure may store information (e.g., a voice file, a video file, a moving path, an executed file name, or the like) collected in the electronic device. Further, the storage unit 130 may include the daily work information extracting program 131 and the user basic information 132. The daily work information extracting program 131 may extract a user's behavior which the information means based on the collected information and display the user's behavior with a text type. Further, the program may display a user's details of a daily work according to a time order and a time table generated by the method may be also stored in the storage unit 130. The user basic information 132 may refer to information used to extract a user's daily work in the collected information. For example, the used information may correspond to a position of a user's home, school, company, or the like. Based on data included in the user basic information 132, the electronic device may determine whether a user has arrived at home or an office on the basis of the GPS signal.

The sensor unit 140 may detect various stimuli including a movement of the electronic device. The sensor unit 140 may include various types of sensors such as an illumination sensor, a proximity sensor, a gyro sensor, an acceleration sensor, a grip sensor, or the like. The sensor unit 140 (e.g., a gyro sensor or an acceleration sensor) according to the embodiment of the present disclosure may detect a movement of the electronic device so as to transmit a signal for the movement to the controller 180. The signal for the movement may be used as a material determining an alarm time point which notifies that the user's the details of the daily work has been generated. (for example, the alarm may be performed after a predetermined time if no movement is detected for more than 10 minutes.) In addition, the sensor unit 140 may be used as a device for collecting the event information when an event related to the user's daily work is generated. For example, the sensor unit may collect odor information for determining whether on user eats a meal using an odor sensor. Further, the acceleration sensor and the gyro sensor may collect user's movement information so as to determine whether a user exercises such as running, walking, or the like by the collected information.

The wireless communication unit 150 may include a wireless frequency transmission unit for upward converting and amplifying a frequency of a transmitted signal, and a wireless frequency reception unit for downward converting and low-noise amplifying a frequency of the received signal. Also, the wireless communication unit 150 may include the mobile communication module 151, the GPS module 152, the Wi-Fi module 153, the NFC module, and the like. When a user's movement is generated, the wireless communication unit 150 according to the embodiment of the present disclosure may receive data related to a location using the GPS module 152 from a time point in which an event for the movement is generated. The data may be transmitted to the controller 180 so as to be used to understand information of a moving distance, a current position, and the like. In addition, the wireless communication unit 150 may detect a Wi-Fi signal using the Wi-Fi module 153 and collect information of a wireless router which detects the Wi-Fi signal. The Wi-Fi module 153 may transmit data for sensitivity of the detected Wi-Fi signal and data of wireless router information (ex, SSID; Service Set Identifier) to the controller 180. The information on the Wi-Fi signal and the router may be used to understand a user's detailed location information. Further, the NFC module 154 may receive tag information attached to a specific place (e.g., a home, a vehicle, or the like) which is pre-configured by the user. The received tag information may be used to understand information such as a user's current location and whether a user rides in vehicles. The NFC module 154 can perform a transportation card function and a payment function and collect information when a payment is performed using the NFC. Furthermore, the wireless communication unit 150 my receive a push notification generated in an interworking application (e.g., Social Network Service (SNS), news, email, or the like) using the mobile communication module 151 so as to enable information to be provided to the controller 180 in order to manage the user's daily schedule. Also, the wireless communication unit 150 may perform a reception and a transmission of a text message, a call, or the like and collect data related to the wireless communication.

The camera 160 performs a function of photographing a subject under a control of the controller 180. The camera 160 may include a lens for collecting light and an image sensor for converting the collected light into an electronic signal. The camera 160 according to the embodiment of the present disclosure may photograph an image, a video, or the like and be attached around a user's eye so as to photograph a surrounding environment which is within a line of sight of the user in an electronic device formed in a glasses type. Further, when a user's specific event (e.g., facial recognition and conversation detection of a pre-stored another person) is generated, the camera 160 may photograph a video by operating the camera 160 at the time point in which the specific event is generated. The camera 160 may photograph a specific place and the photographed data may be used as a material for generating the user's details of the daily work.

The audio processor 170 may perform an input and an output of an audio signal for voice recognition, an audio recording, and a call by combining a speaker and a microphone. The audio processor 170 according to the embodiment of the present disclosure may input a voice by always maintaining a turned-on state or repeatedly turning on and off in a predetermined period. Therefore, a voice event may be comparatively immediately detected and the voice event is an event which is defined when a voice is detected for more than or equal to a predetermined time (e.g., more than or equal to 20 seconds). When the voice event is generated, the controller 180 may perform an audio recording or a video photographing. In this event, the audio processor 170 may convert a voice into an electronic signal for the voice recording so as to enable the converted voice to be transmitted to the controller 180. In addition, when an audio related operation is performed in a call event and a specific application execution event, the audio processor 170 may convert the voice into the electronic signal for the audio recording or convert voice data into an analog sound in order to output a sound.

The controller 180 may control general operations of the electronic device. The controller 180 according to the embodiment of the present disclosure may determine whether an event related to the user's daily work is generated. For example, when the electronic device detects an incoming call and a call performance, the controller 180 may classify the situation as a user's call event and record a user's call history to record the call history. When a user's movement event has been detected, the controller 180 may activate the wireless communication unit 150 so as to enable a GPS signal to be received. When a conversation is maintained for more than or equal to a predetermined time interval, the controller 180 may order to record a voice of the conversation or photograph a video. The event related to the user's daily work may include a voice event in which a pre-stored voice is detected for more than or equal to a predetermined time interval, a crash event which an external impact of the electronic device is detected through a sensor, a payment event, an application execution event when a specific application execution is detected, or the like. Further, the controller 180 may record data of a photographing and an audio recording in response to each event occurrence.

Also, based on information collected in a pre-determined specific situation as described above, the controller 180 may generate user's details of the daily work which the information means. The controller 180 may be based on the daily work information extracting program 131 and the user basic information 132 which are stored in the storage unit 130 when the details of the daily work is generated. For example, when a location of “home” among the user basic information 132 has been stored and a movement of the GPS signal stays for more than or equal to a predetermined time at the “home”, the controller 180 may add a text of “arrive at home” to the details of the daily work. The controller 180 may switch the collected event information (e.g., a movement, a call, a payment, or the like) into a text using a template, or the like included in the daily work information extracting program 131.

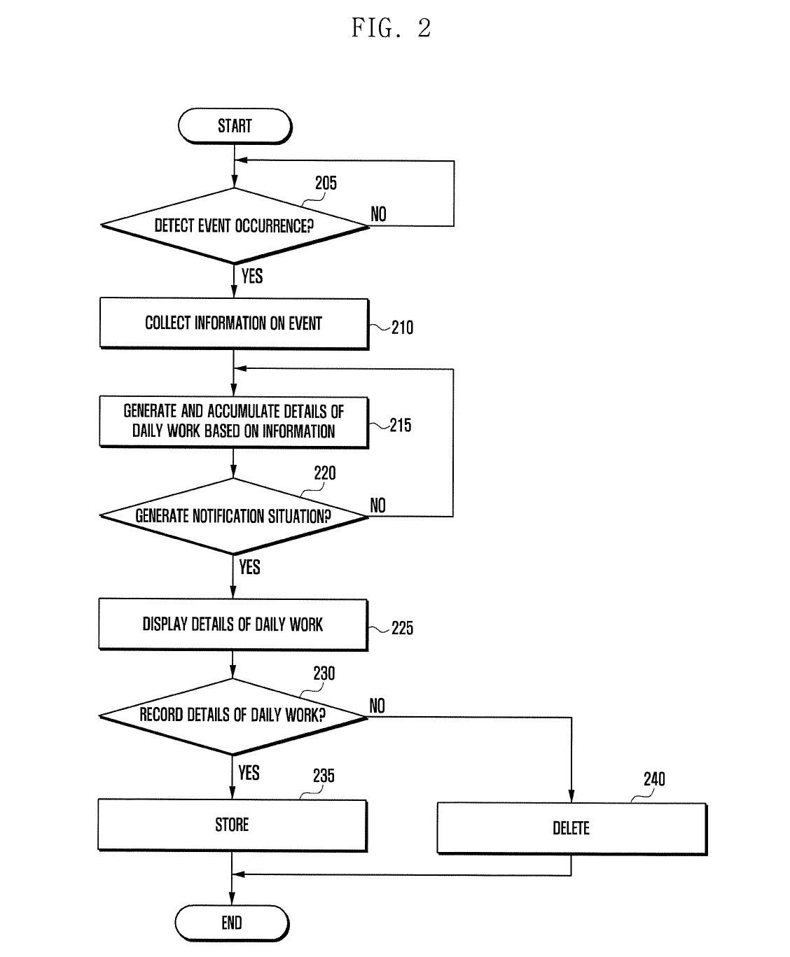

FIG. 2 illustrates a process of an order of a daily work management operation in an electronic device according to an embodiment of the present disclosure.

Firstly, the controller 180 may detect an event occurrence related to a daily work in operation 205. The event refers to a pre-configured event occurrence by the daily work information extracting program 131. The event occurrence may correspond to, for example, a call or text message reception, an NFC tag operation, a movement detection based on a Wi-Fi signal and a GPS signal, a conversation voice detection, a media play, a file transmission, a DMB watching, or the like. When the event occurrence has been detected, the controller 180 may collect information related to the event in operation 210. For example, when the movement event has been detected, the controller 180 may collect a GPS signal which is information related to the movement event. In the embodiment as described above, the GSP signal is information including a movement distance, a location, a movement speed, or the like and a user's departure position, a way point, a transportation means, or the like may be extracted based on the information.

The controller 180 may generate details of a daily work based on the information and accumulate the generated data so as to enable the accumulated data to be temporarily stored in operation 215. In addition, the controller 180 may determine whether a notification situation has been generated in operation 220. The notification situation refers to a time point which notifies that collected information and user's details of the daily work generated based on the collected information exist. The notification situation may be configured after a specific time according to a user's configuration. For example, the notification situation is after “9 P.M.” and may be configured as a time point at which 5 minutes have passed without detecting a movement of the electronic device. When a pre-configured notification situation has been generated, the controller 180 may display the details of the daily work in operation 225. Alternatively, the controller 180 may display a message, an icon, or the like which notifies that the details of the daily work exist in operation 225. When the notification situation has not been generated, the controller 180 may return to operation 215.

The controller 180 displays the details of the daily work and then may identify whether the details in the electronic device are to be recorded in operation 230. For example, the operation 230 may be an operation of displaying a selection window including a message for asking whether the details in the electronic device are to be recorded. Further, when a record determination has been identified, the controller 180 may store the details of the daily work in the electronic device or an external storage in operation 235. When the record determination has not been identified, the controller 180 may delete the details of the daily work in operation 240. Therefore, the user can record only the details of the daily work which the user wants to record, other than all the daily works. The operation of FIG. 2 may be terminated after storage or deletion of the details of the daily work.

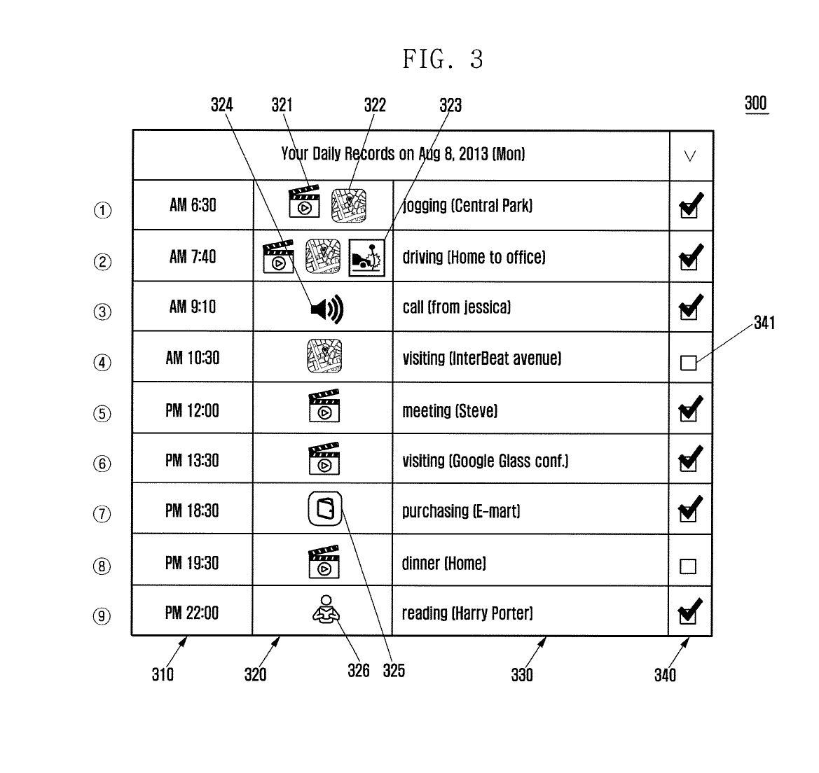

Hereinafter, the operation proposed in FIG. 2 will be described in more detailed in reference to FIGS. 3 to 7.

FIG. 3 illustrates a time table type of details of a daily work according to an embodiment of the present disclosure.

In accordance with FIG. 3, a time table 300 enters details of a daily work of a specific work in chronological order. First, a column indicated by a reference numeral 310 is an area where a time, at which an event related to a daily work is generated, is recorded. Further, a column indicated by reference numeral 320 is an area illustrating a program used for an identification of the recorded event. For example, when the user's movement event is generated, a moving path may be recorded in an application which detects a GPS signal so as to display a map. In this event, a program which records a movement event and displays recorded data may be a map application. Accordingly, when the event has been recorded, the column indicated by reference numeral 320 may display an icon corresponding to a map program. In addition, when an event recording type is a video, an application supporting a video playback may be displayed in the column indicated by reference numeral 320.

Further, a column indicated by reference numeral 330 is an area where user's details of a daily work inferred based on a recorded event is entered. A column indicated by reference numeral 340 is a selection box for supporting to select only details to be stored of displayed entire details of the daily work. The selection box may be allocated by each daily work item so as to enable a selection to be performed for each item.

Details of the daily work displayed in the time table 300 may be extracted from a recorded event material as described above. In row 1, a record of an event generated at 6:30 A.M is noted. In row 1 column 320, an icon of a program which can identify the event recorded at 6:30 A.M is displayed. First, it is possible to identify that an event recorded as a video exists through the video program icon 321. Also, it is possible to identify that a movement event exists through a map program icon 322. When each icon is selected, a record of a corresponding event may be read. For example, when the map program icon 322 has been selected, the controller 180 may display data where a user's event starting location, a moving distance, or the like is displayed on a map. The controller 180 may extract details of a daily work based on the recorded data. When a schedule adjustment is satisfied based on a pre-stored template, the extraction may involve a process of switching the recorded data into a corresponding text. For example, when recorded data is movement data and a moving speed is less than or equal to 5 km/hours, the controller 180 may interpret the recorded data as a jogging based on the pre-stored template so as to enable a text of “jogging” to be switched and then displayed. When the details of the daily work are generated according to the movement event, location information of the GPS signal of the electronic device may be displayed together. In row 1 column 330, “Central Park” is listed such that a place in which the jogging is performed can be identified. However, the text of the “Jogging” can be extracted based on not only a location material but also other various record data. For example, a movement of the electronic device, existence or non-existence of a location movement, or the like is identified by combining a record of video data and a gyro sensor with a GPS signal and a text related to a daily work which is proper for an identified condition may be extracted. In the details of row 1, data recorded at 7:40 A.M is displayed. In row 2 column 320, a video program icon, a map program icon, and an icon of a program 323 which notifies of details of an accident occurrence are displayed. The icon of a program 323 which notifies of the details of the accident occurrence may be a program of recording an accident location, an accident form, or the like such as a black box inside a car. Based on the icons displayed in row 2 column 320, it is possible to infer that an accident had occurred while moving. In row 2 column 330, it is possible to identify that “driving (Home to office)” has been entered. The “driving” can be displayed when a moving speed is more than or equal to a pre-configured reference as a result of reading a GPS signal. Further, the controller 180 may use NFC tag connection information attached to an interworking car in order to extract the text of “driving”. When an NFC tag connection is set to be detected when the user gets into a car, the controller 180 may identify whether the user has gotten into the car. Therefore, when information on whether a user rides in vehicles and a movement have been detected by using the NFC tag information, the controller 180 may be configured to extract the text of “driving”. In addition, a place name of a view point of the user which is referred as to “Home” or “Office” may follow a pre-stored configuration in the user basic information 132. Therefore, the controller 180 may identify whether a pre-stored location in the user basic information 132 or a specific place name detected using a GPS, or the like is a user's “Home” or “Office” by wireless router information (ex, SSID). The controller 180 may display details of a daily work by being switched into a text of “Home to office” based on the identified information.

In addition, an event recorded at 9:10 A.M is recorded in row 3. In row 3 column 320, a sound playback program icon 324 is included. When the icon has been selected, a recorded voice event may be played back. The controller 180 may record a user's voice by turning on a microphone when an incoming call is generated. When a voice which coincides with a pre-stored user's voice has been detected using a microphone which performs an on/off operation having a predetermined period, the coinciding voice may be recorded. When the recording has been performed, the recorded data may be identified in the time table 300. When a voice has been recorded based on an incoming call occurrence, the controller 180 may define the event as a text of “call”. When a calling number is a number previously stored in a phone book, a name of a person corresponding to the calling number can be also entered as shown in row 3 column 330.

In row 4, an event recorded at 10:30 A.M. is displayed. In row 4 column 320, a map program icon is displayed. The user may predict an occurrence of a movement event through the icon display. Further, in row 4 column 330, details of a daily work is entered in a type of “visiting (place name)”. For example, when a GPS signal stays for more than or equal to a predetermined time interval at a place not included in the user basic information 132, the controller 180 may consider the situation as “visiting”. Also, the place name may be identified based on data in the map program. In a selection box which is in row 4 column 340, a check mark has been cleared. Each selection box displayed in column 340 may be created such that items of the details of the daily work of each row may be checked or un-checked. In addition, when the details of the daily work are to be stored, the user may separately store only an item of which the selection box has been detected.

In row 5, an event recorded at 12:00 PM is displayed and in column 320, it is displayed that video data has been recorded. For example, the video data may be recorded when voices of two or more people including a user have been detected. When a face of a specific person stored in the user basic information 132 has been detected by a camera which can turn on/off in a predetermined period, the video data may start being photographed. In this event, the controller 180 may identify a person who the user converses with based on an image or voice information stored in the user basic information 132 and the identified information may be included in details of the daily work to be entered in column 330. When a voice of another person other than a user's voice has been recorded or a video including a face of a user's acquaintance has been photographed, the controller 180 may consider the situation as a “meeting”.

In row 6 column 320, it is possible to identify that video data also exists and it is possible to identify that “visiting (Google Glass conf.)” has been recorded in row 6 column 330. It is possible to identify that a place name in the parentheses is not a specific area name but a conference name. The controller 180 may use not only the GPS signal but also the video data as a method of defining “visiting”. In addition, the controller 180 may enter a pre-stored daily work name in a scheduler instead of an area name (or a building name) in the parentheses when the “visiting” is defined. For example, when a pre-stored schedule exists in a user's scheduler (a program with a type in which a user directly writes the user's schedule) and a time slot of an event occurrence and recording is a time interval corresponding to the pre-stored schedule, the controller 180 may enter a schedule of a corresponding time previously stored in the scheduler in the parentheses when the “visiting” is defined.

In row 7, details (referring to column 330) in which a purchase is made at 18:30 PM (referring to column 310) are recorded. The details for the purchasing may be identified when an icon displayed in row 7 column 320 has been selected. When the purchasing is a transaction on the Internet, a name of a shop in which a payment has been performed may be recorded together. Also, even though the purchasing is performed offline, the purchasing may be recorded as a payment event. For example, when an expenditure notification message has been received at a time in which a credit card is used, the controller 180 may detect an event occurrence and extract details of a daily work based on the received message content.

In row 8, details of a daily work generated at 19:30 PM are displayed. Referring to row 8 column 320, it is shown that video data is data which becomes a basis of the details of the daily work. In row 8 column 330, details of a daily work referred to as a “dinner(Home)” is entered. The details of the daily work of row 8 can detect an event occurrence and be recorded through an audio recording or a video photographing when voices of two or more people including a user's voice has been detected to be similar to the situation of defining “meeting”. An additional condition other than a condition in which a voice should be detected can be further used in order to define the “dinner”. For example, aside from the voice detection, when a food order has been detected by utilizing an odor sensor which detects an odor, the controller 180 may define the situation as “breakfast”, “lunch”, “dinner”, or the like according to an event occurrence time so as to enable the defined situation in row 8 column 330 to be displayed. Further, the controller 180 may provide information on a place where a user has a meal by additionally entering an event occurrence place based on the GPS signal in row 330.

In row 9, an event generated at 22:00 PM is displayed. An icon 326 displayed in row 9 column 320 may correspond to a program which displays whether a user reads an electronic book, an electronic book execution program, or the like. Also, when the electronic book program has been executed, the controller 180 may consider a reading event occurrence and display a text of “reading” in column 330. When the “reading” is defined as details of a daily work, the controller 180 may enter “reading” together with a title of a book executed in the electronic book program in parentheses.

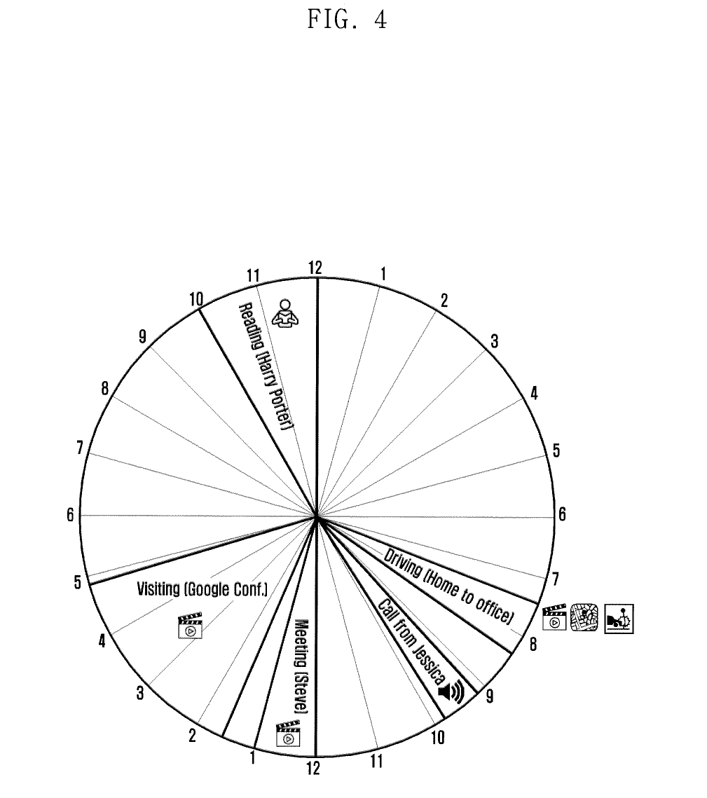

Column 340 is a selection box configured to enable each detail of a daily work to be selected or deselected and may be displayed together in the time table 300 in order to select an item to be stored among the details of the daily work entered in the time table 300. FIG. 4 illustrates that a specific item selected using a selection box displayed in column 340 is only entered in a circular form. FIG. 4 illustrates a function of supporting only a selected item among generated details of the daily work to be stored according to an embodiment of the present disclosure. When only the specific item desired to be stored by the user among extracted details daily work is to be stored, the daily work generating program may provide various types other than a time table and a circular form.

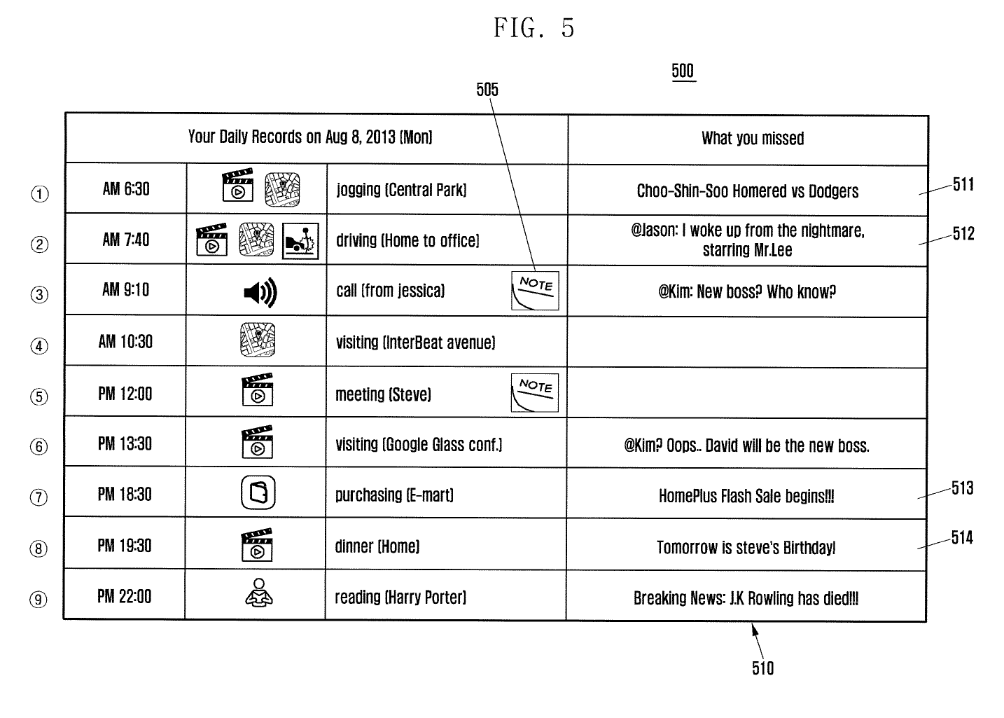

FIG. 5 illustrates details of a daily work displayed by being interconnected with an auxiliary program according to various embodiments of the present disclosure.

FIG. 5 illustrates a form of extracting details of a daily work by utilizing internet information as a method by which the details of the daily work are extracted.

According to a time table 500 of FIG. 5, details of a daily work are extracted by utilizing news, social network information, or the like in column 510. A social networking service provides a service for transmitting a short message, a mail, or the like to a user. In addition, since reception time information is included in a received message or mail, the controller 180 may utilize an interworking social networking service together when the details of the daily work are extracted using the reception time information. When the user designates a theme, or the like of news in which the user is interested in to set a life logging function, the controller 180 enables the details of the daily work to be extracted by utilizing update information of the news.

First, reference numeral 511 illustrates that news of a pre-configured theme (e.g. sports) is provided in details of a daily work by a user. Reference numeral 512 illustrates that update information of the social networking service is provided in details of a daily work. Reference numeral 513 also illustrates that news of a pre-configured theme (e.g. shopping) is provided in details of a daily work by the user and reference numeral 514 illustrates that birthday information of friends provided in the social networking service is extracted in the details of the daily work. The daily work managing method according to the present disclosure may provide a method of identifying update information of the news or the social networking service which the user can miss together with the details of the daily work. In addition, the details of the daily work may add a short memo 505 in order to correct an error which can be generated when the details of the daily work are extracted and write additional information for each item.

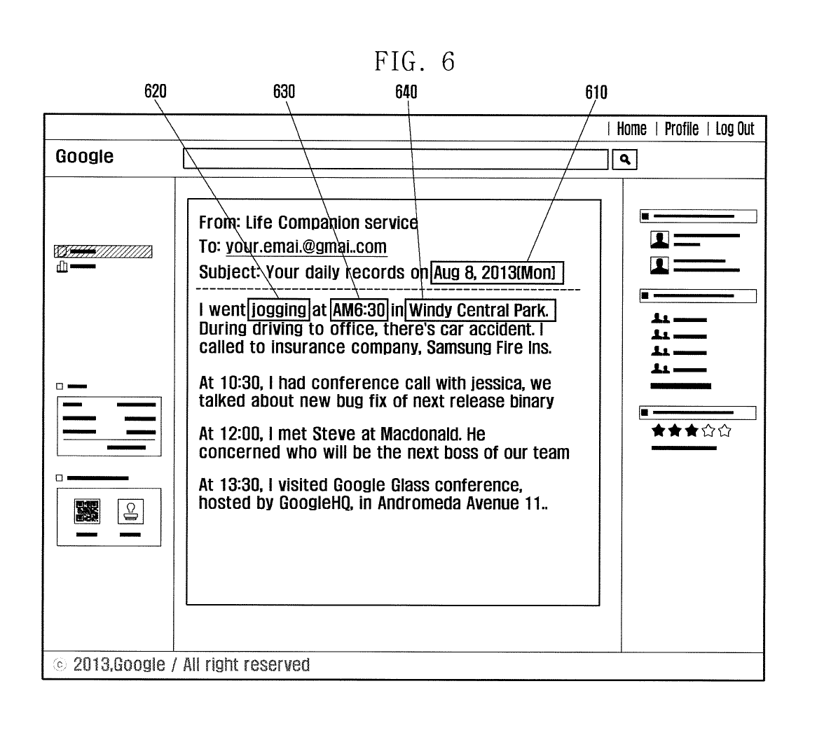

FIG. 6 illustrates details of a daily work stored in a diary form in a daily work management method according to an embodiment of the present disclosure.

When a pre-configured notification situation is generated so as to cause extracted details of a daily work to be shown to a user in a time table type, a specific item may be only stored according to a user's selection and extracted whole details may be stored. In addition, the controller 180 may support various types in which the details of the daily work are stored. For example, a diary, a time table, and a circular form may correspond to the various types. When the details of the daily work are to be stored in a diary type as shown in FIG. 6, the controller 180 may make a sentence using each item of pre-extracted details of a daily work. An element of making the sentence of the diary may include date information 610, a time 630, a place 640, or the like at which each event is generated other than details of a daily work 620 extracted as a text in each event. The dairy which is formed as described above may be transmitted by mail according to a user's selection and be stored in the storage unit 130 of the electronic device.

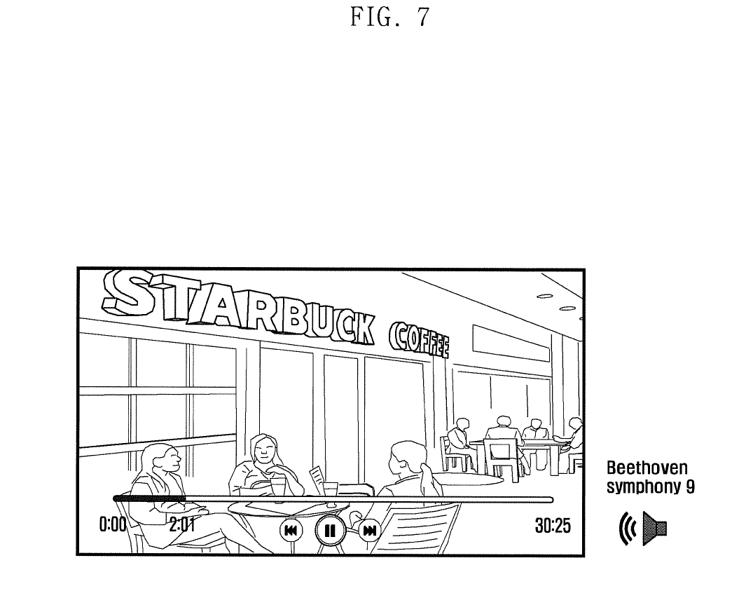

FIG. 7 illustrates that data related to an event is executed in a daily work management method according to an embodiment of the present disclosure.

Heretofore, it has been described that data related to each event may be recorded and the data can be read. When an event requiring to execute a video photographing has been generated (e.g., when a conversation of two or more people has been detected), the controller 180 may perform a video photographing. The photographed video data may be played back later as shown in FIG. 7 and when an audio file which is being executed when an event occurs exists, the audio file may be played back together with the video.

The various embodiments of the present disclosure as described above may be implemented in the form of a program instruction that can be performed through various computers, and may be recorded in a computer readable recording medium. The computer readable recording medium may include a program command, a data file, and a data structure independently or in combination. The program instruction recorded in the recording medium is specially designed and constructed for the present disclosure, but may be well known to and may be used by those skilled in the art of computer software.

The computer readable recording media may include a magnetic media such as a hard disc, a floppy disc, and a magnetic tape, an optical recording media such as a Compact Disc Read Only Memory (CD-ROM) and a Digital Versatile Disc (DVD), a magneto-optical media such as a floptical disk, and a hardware device, such as a Read Only Memory (ROM), a Random Access Memory (RAM), and a flash memory, specifically configured to store and execute program instructions. Further, the program command includes a machine language code generated by a compiler and a high-level language code executable by a computer through an interpreter and the like. The aforementioned hardware device may be configured to operate as one or more software modules in order to perform the operation of the present disclosure, and vice versa.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method of managing a daily work using an electronic device, the method comprising:
recording data related to an event when an event occurrence related to the daily work is detected; and
displaying details of the daily work generated from the data related to the event on a screen at a time point in which a pre-configured condition is satisfied.

2. The method of claim 1, wherein the displaying of the details of the daily work on the screen comprises:
displaying an icon or a notification window notifying that the details of the daily work are generated; and
displaying a whole item of the generated details of the daily work.

3. The method of claim 1, wherein the displaying of the details of the daily work on the screen comprises:
allocating a selection box to each item of the details of the daily work and displaying the each item together with the selection box; and
storing a selected item in the selection box with at least one type among a time table, a circular form, and a diary type.

4. The method of claim 1, wherein the time point satisfying the pre-configured condition comprises a time point at which at least one condition among a specific time, a location of a pre-configured place and existence or non-existence of a stopped state is satisfied.

5. The method of claim 1, wherein the event related to the daily work comprises a voice event in which a pre-stored voice is detected during a predetermined time interval, a movement event, a call connection event, a crash event in which an external impact of an electronic device is detected through a sensor, a payment event, and an application execution event and the recording of the data comprises performing an audio recording, a video photographing, or a moving path recording, in response to the event occurrence related to the daily schedule.

6. The method of claim 1, further comprising:
extracting a text corresponding to details of a daily work from data related to the event.

7. The method of claim 6, wherein the extracting of the text comprises:
extracting a text corresponding to “visiting” in the details of the daily work when a user stays at a specific place for more than or equal to a reference time as a result of analyzing data related to the movement event;
extracting a text corresponding to “walking” in the details of the daily work when the user moves less than or equal to a reference speed, as a result of the data analysis;
extracting a text corresponding to “high-speed movement” in the details of the daily work when the user moves while exceeding to a reference speed, as a result of the data analysis; and
extracting a text corresponding to each place name when location information reaches a pre-stored place, as a result of the data analysis.

8. The method of claim 6, wherein the extracting of the text comprises:
extracting a text corresponding to “conversation” when a voice of another person including a pre-stored user's voice has been detected as a result of analyzing data related to the voice event; and
extracting a conversation counterpart's name by comparing a conversation counterpart's face with information included in an interworking application from a video data when the data is the video data.

9. The method of claim 6, wherein the extracting of the text comprises extracting a text corresponding to “crash” when a signal of a sensor which detects a crash is larger than or equal to a predetermined reference, as a result of analyzing data related to the crash event.

10. The method of claim 6, wherein the extracting of the text comprises extracting a text together with additional information used to generate the details of the daily when the text is extracted based on notification information of a schedule program or an interworking social networking service.

11. A daily work managing apparatus comprising:
a storage unit configured to, when an event related to a daily work occurs, store data related to the event and stores a condition in which details of the daily work generated from the data related to the event are displayed on a screen; and
a controller configured to, when the event related to the daily work occurs, control to record data related to the event and to display details of the daily work generated from the data related to the event on the screen at a time point at which the condition is satisfied.

12. The daily work managing apparatus of claim 11, wherein the controller is configured to control to display an icon or a notification window which notifies that the details of the daily work has been generated and displays a whole item of the generated details of the daily work, when the details of the daily work are displayed.

13. The daily work managing apparatus of claim 11, wherein the controller is configured to allocate a selection box to each item of the details of the daily work to display the each item together with the selection box and stores a selected item with at least one type among a time table type, a circular form and a diary type in the selection box.

14. The daily work managing apparatus of claim 11, wherein the time point at which the pre-configured condition is satisfied is a time point at which at least one condition among a specific time, a location of a pre-configured place, and a movement which a sensor detects is satisfied.

15. The daily work managing apparatus of claim 11, wherein the controller is configured to detect an occurrence of a voice event in which a pre-stored voice is detected during a predetermined time interval, a movement event, a call connection event, a crash event in which an external impact of an electronic device is detected through a sensor, a payment event, and an application execution event as an event related to the daily work and performs an audio recording, a video photographing, or a moving path recording, when the event related to the daily work occurs.

16. The daily work managing apparatus of claim 11, wherein the controller is configured to extract a text corresponding to details of a daily work from data related to the event.

17. The daily work managing apparatus of claim 16, wherein the controller, as a result of analyzing data related to the movement event, is configured to extract a text corresponding to “visiting” in the details of the daily work when it is identified that a user stops at a specific place for more than or equal to a reference time, extract a text corresponding to “walking” in the details of the daily work when it is identified that the user moves less than or equal to a reference speed, extract a text corresponding to “high-speed movement” in the details of the daily work when the user moves while exceeding a reference speed and extract a text corresponding to each place name when location information reaches a pre-stored place.

18. The daily work managing apparatus of claim 16, wherein the controller, as a result of analyzing the data related to the voice event, is configured to extract a text corresponding to “conversation” when a voice of another person including a pre-stored user's voice has been detected and extract a conversation counterpart's name by comparing a conversation counterpart's face with information included in an interworking application from a video data when the data is the video data.

19. The daily work managing apparatus of claim 16, wherein the controller is configured to extract a text corresponding to “crash” when a signal of a sensor which detects a crash is larger than or equal to a predetermined reference, as a result of analyzing data related to the crash event.

20. The daily work managing apparatus of claim 16, wherein the controller is configured to extract a text together with additional information used to generate the details of the daily work when the text is extracted based on notification information of a schedule program or an interworking social networking service.
